(19) United States
(12) Patent Application Publication
(10) Pub. No.: US 2013/0174085 A1
(43) Pub. Date: Jul. 4, 2013

(54) INTERACTIVE ONLINE SHOWING

(71) Applicants: JOAN ELIZABETH PEARSALL, MILLBURY, MA (US); KIMBERLY MAY WALDRON, Millbury, MA (US)

(72) Inventors: JOAN ELIZABETH PEARSALL, MILLBURY, MA (US); KIMBERLY MAY WALDRON, Millbury, MA (US)

(21) Appl. No.: 13/669,015

(22) Filed: Nov. 5, 2012

Related U.S. Application Data
(60) Provisional application No. 61/555,373, filed on Nov. 3, 2011.

(51) Int. Cl. G06F 3/0485

(52) U.S. Cl. CPC G06F 3/0485
USPC 715/784; 715/781

(57) ABSTRACT

A system for visually presenting various views of an object. The system comprising a computer display in which is presented a plan view window including a plurality of locator icons thereupon, an image window and a movable cursor adapted to select a specific locator and to cause a view of the object as seen from that locator icon position to appear in the image window.

### CROSS-REFERENCE TO RELATED APPLICATIONS

This application claims the benefit under 35 U.S.C. §119(e) of U.S. Provisional Application No. 61/555,373 filed Nov. 3, 2011, which is entirely incorporated by reference into this document.

### STATEMENT REGARDING FEDERALLY SPONSORED RESEARCH OR DEVELOPMENT

### FIELD OF THE INVENTION

This invention involves a system for managing and presenting various views of an object.

### BACKGROUND OF INVENTION

This interactive online building showing system integrates photographs of a building exterior and interior with a floor-plan view of the building in order to create a completely interactive viewing experience.

Most prospective home buyers begin their home search online looking at photographs of potential homes. Prior systems for viewing potential real estate online have included photographs presented individually or alternatively strung together in a slide show format. Occasionally, floor-plan views are also made available as another way to view the real estate. Unfortunately for the prospective buyer these elements have not been integrated or available in an interactive mode. Nor has the viewer been able to view the various parts of the property in an order of their choosing. Nor does the prior systems provide the enjoyable experience to the user that would tend to hold them on the site for an extended period of time, thereby increasing the emotional attachment to the property and ultimately to a purchase decision. Also, prior systems often would take a long time to load the video or slide-show presentation which would be frustrating for the prospective buyer. Finally, the videos and slide-show presentations often require the downloading of proprietary software necessary to view them properly. This can be both an expense to the prospective buyer and a barrier to the buyer's ability to access a particular prior system.

These and other deficiencies with the prior viewing systems have been obviated in a novel manner by the present invention.

An object of this invention is to integrate floor-plans and photographs of a property into a seamless and interactive system of presentation in order to enhance a prospective home buyer's house hunting experience. Having integrated access to both photographs and floor plans of a property gives prospective buyers a unique view of the real estate being presented.

A further object of this invention is to provide a real estate viewing experience that allows the user to view photographs focused on aspects of a building that most interests them.

A further objective of this invention is to provide an interactive online showing system that loads more quickly than standard video, slide-shows or other “virtual tour” type viewing systems. In many current systems the prospective client has to wait an appreciable amount of time for the system to finish down-loading media and to buffer the video or slide-show. If the internet connection slows there can be a substantial time lag while the prospect waits for the media to buffer again.

A further objective of this invention is to provide an interactive online showing system that does not require a specific plug-in or proprietary media platform such as the Adobe Flash Player in order to be usable by the typical prospect. In other words, a system that is efficient and available for immediate use by prospects without the need for specially installed applications.

A further objective of this invention is to provide an interactive online showing system that views equally well on desk top computers, tablets or various types of mobile devices.

A further objective of this invention is to provide a showing experience that is enjoyable such that the prospect is apt to linger longer while viewing potential properties, since, it has been found that a longer viewing time often correlates with a greater emotional attachment to a particular property and that in turn leads to an increased likelihood of the prospect making an actual visit to the site and ultimately to making an offer for the property.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

A system for visually presenting various views of an object. The system comprising a computer display in which is presented a plan view window including a plurality of locator icons thereupon, an image window and a movable cursor adapted to select a specific locator and to cause a view of the object as seen from that locator icon position to appear in the image window.

### BRIEF DESCRIPTION OF THE DRAWINGS

The character of the invention, however, may best be understood by reference to one of its structural forms, as illustrated by the accompanying drawings, in which:

FIG. 1 shows a computer workstation on which an interactive online showing system is operating through a standard internet browser,

FIG. 2 shows the opening page of an embodiment of this invention which includes both one or more floor-plan views of a building presented side by side with an image view window capable of displaying various photographic images of the building, in this figure, the image being a photograph of the building exterior,

FIG. 3 shows a close-up of one floor-plan from FIG. 2 including the presence of a movable cursor and numerous star shaped locator icons indicating positions from which available images were taken, and

FIG. 4 shows the effect within the image view window of having the cursor hover over a particular star shaped location icon.

### DETAILED DESCRIPTION OF THE INVENTION

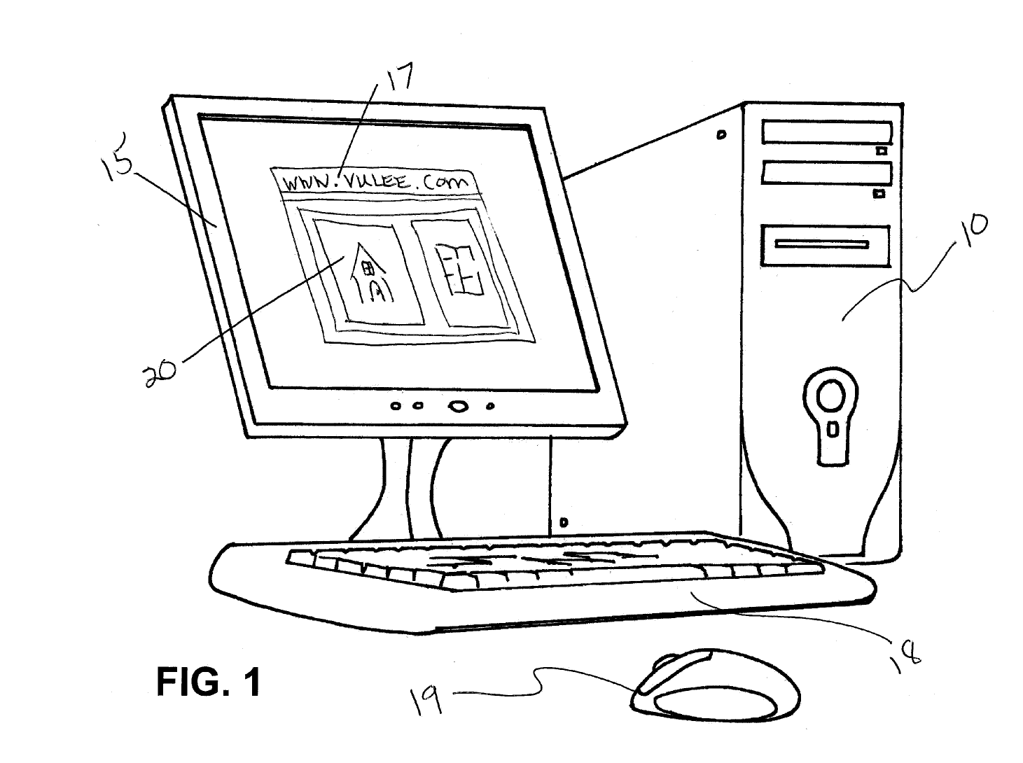

FIG. 1 shows a computer workstation (10) on which an interactive online showing system is operating, the workstation (10) being made up of a computer display screen (15) on which a browser window (17) is launched and in which is displayed a visual presentation (20) of a building. The workstation (10) also includes a cursor moving tool such as a keyboard (18) or a mouse (19).

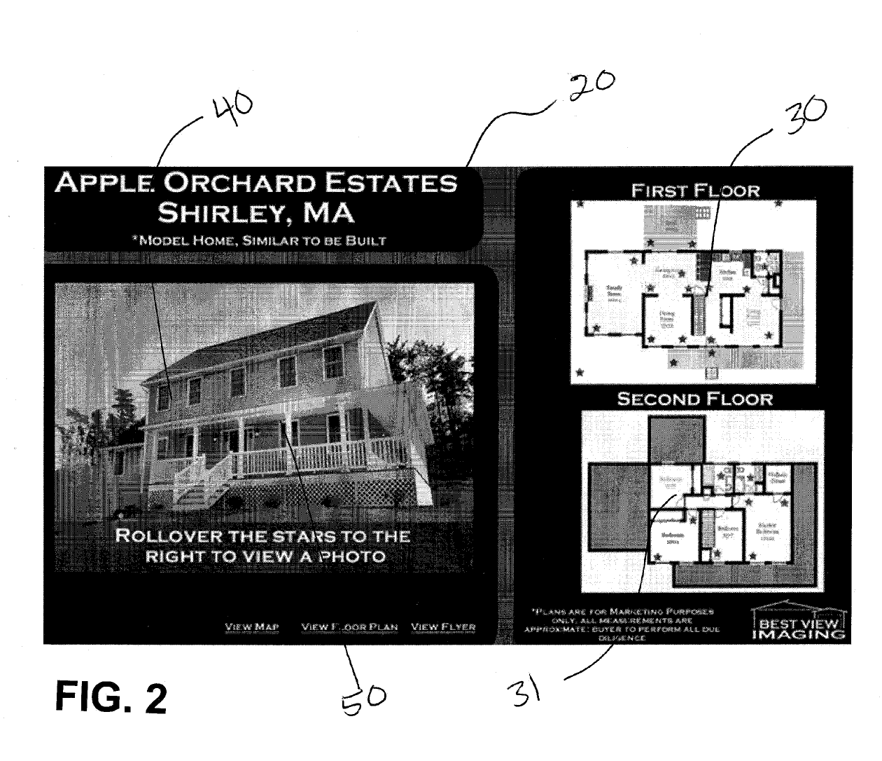

FIG. 2 shows a screenshot of a visual presentation (20) reflecting an opening page of an real estate focused embodiment of this invention. The opening page includes a first floor-plan view (30) and a second floor-plan view (31) both on the right side of the presentation. An image window (40) appears on the left side of the visual presentation showing a photographic image (50) of the building.

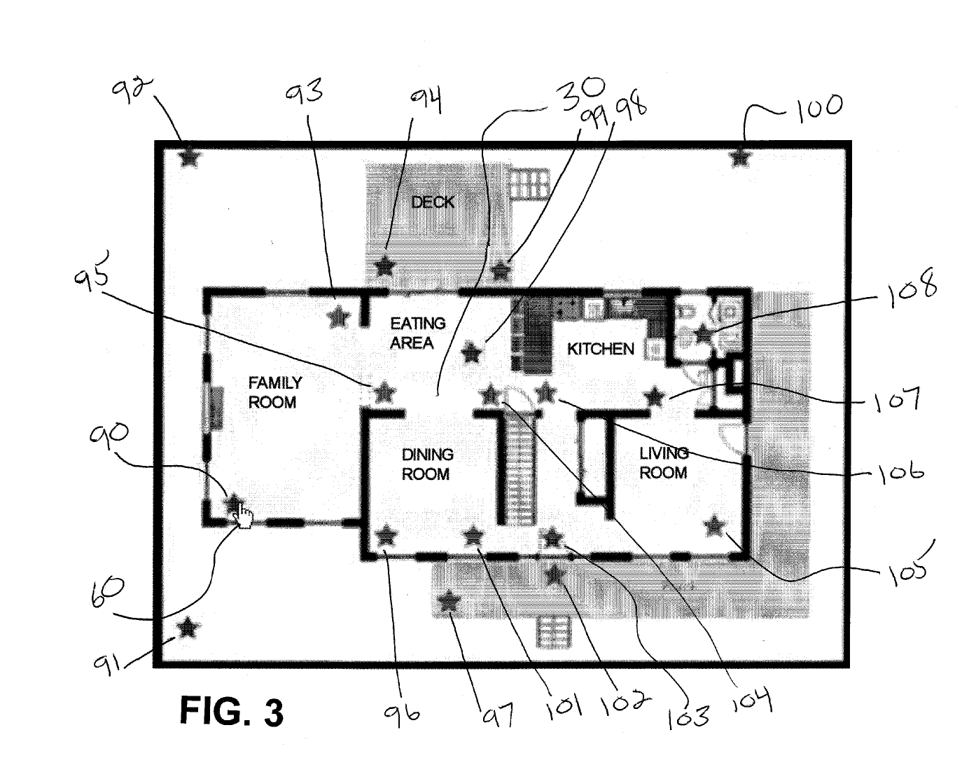

FIG. 3 shows a close-up of the first floor-plan view (30) shown in FIG. 2. In the lower left corner, a movable cursor (60), shaped like a pointing hand, is positioned over a star-shaped locator icon (90). This specific locator icon (90) indicates that an image is available to present in the image window, which image represents a view of the building from that specific location. FIG. 3 shows numerous other locator icons (91-108) wherein each particular locator icon (90-108) represents a building view from it's unique location in the first floor-plan view (30)or the second floor-plan view (31).

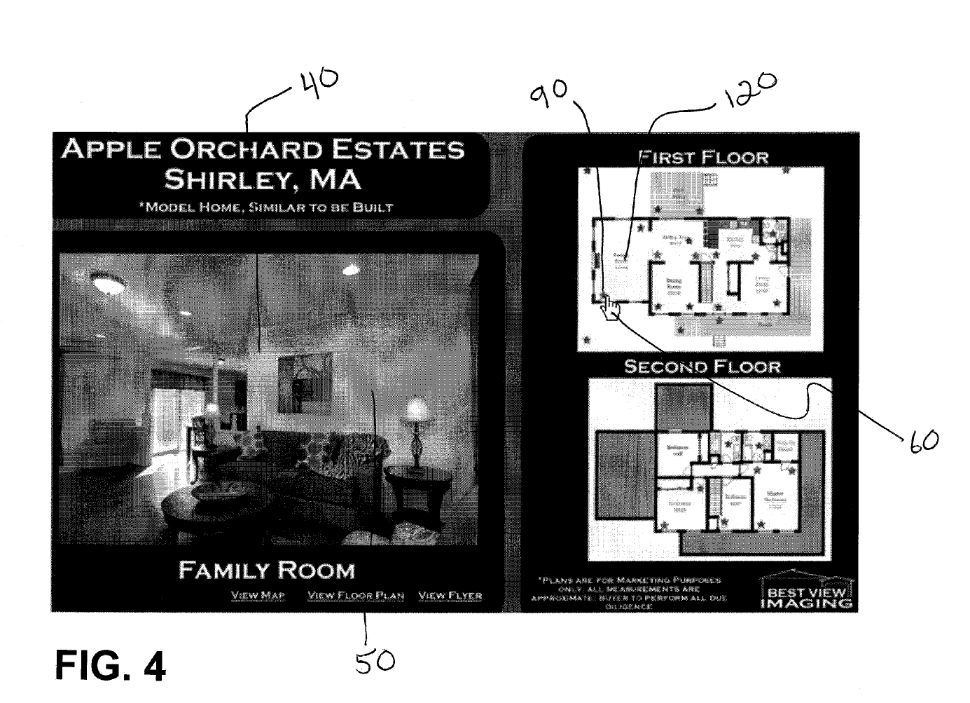

FIG. 4 shows the effect of positioning the movable cursor (60) over the locator icon (90). The image window (40) is transformed to show a photographic image (50) representing a view of the building taken from the particular position of the locator icon (90). In the example shown in FIG. 4, the specific photographic image (50) is of the upper right-hand corner of the family room (120). Thus, the selection of a specific locator icon, for example locator icon (90), using the movable cursor (60) will cause a specific view of the building (50) to appear in the image window (40).

A particular embodiment of this invention envisions a computer workstation displaying floor-plans with star-shaped icons which when rolled-over by a movable cursor will cause a photographic view from that icon to be presented. This system may include property identification information along with links to a flyer and links to further floor-plan views. The system may include as well links to share the real estate information via social media including Facebook, Twitter, or possibly a link to standard email. The system may also include a link to a Google® map of the location. The photograph being presented may be made to pan automatically using either regular photographic images or panoramic images offering to a user a viewing experience that is very intuitive. The system may also include appropriate background music in order to enhance the viewing experience further. Alternatively, the star-shaped icons may be arrow-shaped or similarly directional icons that identify the direction of the image shown from that particular icon location.

The current invention is a unique marketing tool for real estate agents, both residential and commercial, homeowners selling their own homes, property management companies, rental and leasing agents, or others needing to show the layout and features of a building, a house, grounds, particular rooms, or the elements of a new development. The system makes it possible for the prospective buyer to view the property in the order they would like to see it rather than being forced to follow a prescribed visual tour itinerary.

For example, if the prospects are “foodies”, for which the kitchen and dining room would necessarily be a high priority, then they can immediately view the kitchen and possibly from multiple angles. Using the current invention they can visualize, if they wish, the flow to the dining room, as well. This viewing experience could provide the incentive for the prospective buyer to make an initial decision concerning whether the house has potential for them. Use of the current invention saves time when there are many homes that the prospective buyer must view before making a firm decision.

Or, in a second example, a prospect is the parent of young children. Often the parents of young children are most concerned with the presence of a decent back yard, a potential playroom and/or how close the children's bedrooms are from the master bedroom. The current invention allows this prospective buyer to go immediately to viewing the backyard, playroom, etc. In other words, the system allows the buyer the ability to go directly to the priority elements of their house search.

Or, in a third example, a prospect is the parent of teenagers. Often parents of teenagers are concerned that there be enough room for comfortable visits from their children's friends, that there are enough bathrooms, and that there is enough parking to accommodate changing transportation needs. The current invention allows them to focus on these particular aspects of the property and save search time in the process.

As can be seen from the above examples, various types of prospective clients can view their primary areas of interest without needing to wade through viewing areas that have little initial interest or priority for them. It has been found that prospective buyers prefer this method of non-linear, randomly selectable, highly interactive viewing patterns, in place of watching standard videos or slide-shows which run in an order predetermined by the agent or photographer.

Another embodiment of this invention envisions access to a particular showing being available to multiple users simultaneously.

Still another embodiment of this invention envisions viewing a future building development or construction plan using virtual images based on construction plans and landscape topology. This embodiment is envisioned to allow prospective buyers the ability to view a virtual image of the plot layout of their future home. They may also have the option to see the view from that plot or what the building would look like when situated on that plot.

The current invention envisions a set of standardized templates that include the most common aspects of a showing. The specific property related content is added by the developer or the seller as is most convenient and cost effective. The template consists of frames and fields within which are inserted floor plans, a property address, Multiple Listing Service number, a primary exterior image of the building, assorted interior and exterior photographs of the building and other pertinent property related information deemed important to the seller. The overall color scheme of the template may be adjustable to conform to a particular agency's branding colors.

The interactive on-line Showing system can be implemented in the real estate market in a number of ways. The three best methods of implementation that are envisioned are Full-service, Self-service and Paid-service. In a Full-service implementation the site developer is responsible for creating the photographs and floor plans that best represent the property to be viewed. The developer uses the content to produce the specific Showing. In a Self-service implementation, the client uploads photography and floor plans to the site developer who in turn uses that content to produce the specific Showing. In a Paid-service implementation the client provides the developer with whatever photographs and floor plans the client has and the developer works with the client on a fee for service basis to create such further material and site development as is necessary to produce the Showing.

Part of the developers task is to edit the photographs for the best presentation possible on-line. This may involve the enhancement of colors or lighting, the removal of flaws in the photograph, or the removal of visual distractions such as cables, wires for electronics, photos/posters on walls, pet dishes, unsightly shadows, and any other non-essential aspects of a particular image. Those photographs having been properly edited can then be added to a pre-existing HTML related file which properly locates the images within the overall Showing presentation system.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. A system for visually presenting various views of an object, comprising:
a. A visual presentation presented by a computer program on a computer display,
b. A plan view window within the visual presentation and including a plan view and a plurality of locators,
c. An image window within the visual presentation, and
d. A movable cursor adapted to select a specific locator and to cause a view of the object from that locator to appear in the image window.

2. A system for visually presenting various views of an object as in claim 1, wherein the locator is an arrow pointing in the direction of the photographic view presented.

3. A system for visually presenting various views of an object as in claim 1, wherein the view presented is a panoramic view, panning across the area being viewed.
